(19) United States
(12) Patent Application Publication
(10) Pub. No.: US 2007/0174474 A1
(43) Pub. Date: Jul. 26, 2007

(54) SYSTEM AND METHOD FOR PROVIDING FEEDBACK AND FORWARD TRANSMISSION FOR REMOTE INTERACTION IN RICH MEDIA APPLICATIONS

(75) Inventors: Daidi Zhong, Tampere (FI); Vidya Setlur, Cupertino, CA (US); Ramakrishna Vedantham, Sunnyvale, CA (US); Miska Hannuksela, Ruutana (FI); Tolga Capin, Fort Worth, TX (US)

Correspondence Address: FOLEY & LARDNER LLP, P.O. BOX 80278, SAN DIEGO, CA, 92138-0278, US

(73) Assignee: Nokia Corporation

(21) Appl. No.: 11/557,614

(22) Filed: Nov. 8, 2006

Related U.S. Application Data
(60) Provisional application No. 60/734,394, filed on Nov. 8, 2005.

(51) Int. Cl. G06F 15/16

(52) U.S. Cl. 709/230; 709/217

(57) ABSTRACT

A system and method for providing feedback formats and transport protocol extensions to support interactivity between a rich media client and a rich media server. The present invention provides for feedback formats and protocol extensions for protocols such as SMS, MMS, HTTP and RTSP. These feedback formats and protocol extensions may be used for dynamic menus, rich media players, user voting situations, video/audio selection services, remote user interfaces, and other applications.

### FIELD OF THE INVENTION

The present invention relates generally to the use of rich media such as scalable video graphics (SVG). More particularly, the present invention relates to the use of feedback mechanisms for supporting interactivity dedicated for rich media between a client and a server engaged in a rich media-sharing environment.

### BACKGROUND OF THE INVENTION

Rich media content is referred to as dynamic, interactive content that is graphically rich. Rich media content contains compound or multiple media, including graphics, images, timed text, text, video and audio, and is delivered through a single interface. Scalable video graphics is the main container for rich media presentations. Until recently, applications for mobile devices were text-based with limited interactivity. However, as more wireless devices are equipped with color displays and more advanced graphics rendering libraries, consumers are demanding a richer experience from all of their wireless applications. A real time rich media content streaming service is imperative for mobile terminals, especially in the areas of mobile broadcast/multicast services such as the 3^{rd} Generation Partnership Project (3GPP) multimedia broadcast multicast service (MBMS), 3GPP2 BCMCS, DVB-H IPDC, mobile streaming services such as 3GPP PSS, 3GPP2 MSS etc. and multimedia sharing services such as the multimedia messaging system (MMS).

SVG is designed to describe resolution independent 2D vector graphics. SVG also often embeds other media such as raster graphics, audio, video. SVG allows for interactivity using the event model and animation concepts borrowed from the synchronized multimedia integration language (SMIL). In addition, SVG also allows for infinite zoomability and enhances the power of user interfaces on mobile devices. As a result, SVG is gaining importance and becoming one of the core elements of multimedia presentation, especially for rich media services such as MobileTV, live updates of traffic information, weather, news, etc. SVG is extensible markup language (XML)-based, allowing more transparent integration with other existing web technologies than prior systems.

Mobile Scalable Vector Graphics (Mobile SVG) has been adopted as the new imaging standard by the Third Generation Partnership Project (3GPP) for playing a pivotal role in bringing improved graphics and images to mobile devices. Recently, 3GPP and the Open Mobile Alliance (OMA) have begun work on rich media based standardization activities.

Currently, there are no feedback mechanisms to support interactivity dedicated for rich media between a client and the corresponding server engaged in a rich media-sharing environment. Although there are some mechanisms for feedback and forward transmission dedicated for media formats such as audio and video, these formats primarily concern the reporting of packet loss, transmission quality and media repair information.

During a rich media presentation, a user can often interact with the client to request more information, update the content, or even send some information back to the server. Such interactions can either occur immediately, or the interactions may be used later for collecting data, for example. Currently, feedback mechanisms associated with audio, video media typically can comprise a report of packet loss, quality measures, or controlling information (e.g. play, pause, record, etc.). However, there currently exists no solutions for mapping events occurring in SVG content to actual feedback requests and forward transmission. Additionally, there currently exists very little functionality in application-level protocols such as hypertext transfer protocol (HTTP), real time streaming protocol (RTSP), etc. for the transmission of such SVG-based information during a rich media presentation with low delay.

Although there are a number of partial solutions for problems associated with local (client-side) interactivity and remote interaction, such as HTTP GET/POST, in an SVG-like rich media presentation, each has its own drawbacks. SVGT 1.2 supports events in the DOM3 event category, as discussed at www.w3.org/TR/DOM-Level-3-Events/, as well as a number of SVG specific events such as “connectionData”, “preload”, “loadprogress”, “postload.” SVG content can be interactive (i.e., responsive to user-initiated events) by utilizing the different features in the SVG language. For example, user-initiated actions, such as a key-presses, can cause animations and/or scripts to execute or cause listener elements to trigger handler elements. A user can initiate hyperlinks to new web pages through actions such as a stylus click on a particular graphics element. In many cases and depending on the value of the “zoomAndPan” attribute of the “svg” element and on the characteristics of the user agent, users are able to zoom into and pan around SVG content.

A number of different aspects of SVG are affected by events. For example, the SVG uDOM enables a script to register event listeners so that the script can be invoked when a given event occurs. Additionally, the event attribute on the ‘handler’ element specifies which event the handler should trigger. Still further, SVG's SMIL animation elements and media elements can be defined to begin or end based on events.

The SVG event model, which is discussed in detail at www.w3.org/TR/SVGMobile12/script.html, is based on the XML event model, which is described at www.w3.org/TR/xml-events/. SVG Tiny uses XML Events to provide the ability to listen to custom events, as well as to specify the event listener separately from the graphical content.

Although some level of interactivity can be provided using SVG's built-in mechanism of declarative animation, the use of scripting provides certain advantages by adding new types of functionality, such as obtaining the current system time for an interactive clock, for example, and can further extend SVG's animation functionalities. Although SVG does not require the support of any particular scripting language, ECMAScript (which is discussed at www.w3.org/TR/SVGMobile12/script.html) is most often used for scripting SVG. Also, ECMAScript is a standardized language developed form Netscape's JavaScript. However, the current functionality provided by SVG primarily concerns local interactivity on the client side via declarative animation and scripting. Functionality for remote interaction is fairly limited with the use of hyperlinks for invoking HTTP GET/POST commands.

The Lightweight Applications Scene Representation (LASeR) system, which is discussed at www.mpeg-laser.org/documents/LASeRStudyOffCDBusan.pdf, has defined a mechanism for sending feedback data by HTTP GET requests and hyperlinks. For example, if the URL of the original content (served by a servlet) is www.example.org/service, then there are several methods of sending an HTTP GET/POST. One method involves sending simple information without an answer (e.g., www.example.org/service?answer1=yes). Another method involves sending simple information with an answer. In this case, the servlet answers by sending either a new scene or an update (packaged in an appendix, for example). A third method involves transmitting complex information, using a script with Add commands which add scene information to an existing url. For example, a subway station is chosen and the name of the station is present in
<text id=“t1”>Corvisart</text>
Existing url in <a id=“ul” xlink:href=“http://www.example.org/service?answer1=”/>
Add selected subway station through Add command, resulting in:
http://www.example.org/service?answer1=Corvisart
<Add ref=“ul” attributeName=“xlink:href” operandID=“t1” operandAttribute=“textContent”/>
Send the url by activating the <a> element
<SendEvent event=“activate” ref=“t1”/>

Unfortunately, this solution is limited to HTTP based connections, which are practically dedicated for PtP applications, rather than streaming applications. Therefore, the scope and variety of such feedback is very limited.

The Hypertext Transfer Protocol (HTTP) is an application-level protocol for distributed, collaborative, hypermedia information systems. HTTP is a generic and stateless protocol which can be used for many tasks beyond its use for hypertext, such as name servers and distributed object management systems. These tasks can be implemented through the extension of its request methods, error codes and headers. A feature of HTTP is the typing and negotiation of data representation, allowing systems to be built independently of the data being transferred. HTTP has been in use by the World-Wide Web global information initiative since 1990.

The Real Time Streaming Protocol (RTSP) is an application-level protocol for controlling the delivery of data with real-time properties. RTSP provides an extensible framework to enable controlled, on-demand delivery of real-time data, such as audio and video. Sources of data can include both live data feeds and stored clips. This protocol is intended to control multiple data delivery sessions, provide a mechanism for choosing delivery channels such as user datagram protocol (UDP), multicast UDP and transmission control protocol (TCP), and provide a system for choosing delivery mechanisms based upon real-time transport protocol (RTP). RTSP has some overlap in functionality with HTTP. However, RTSP differs fundamentally from HTTP in that data delivery takes place out-of-band in a different protocol. HTTP is an asymmetric protocol where the client issues requests and the server responds. In RTSP, both the media client and media server can issue requests. RTSP requests are also not stateless. RTSP is similar in syntax and operation to HTTP/1.1 so that extension mechanisms to HTTP can in most cases also be added to RTSP.

U.S. Patent Application Publication No. 2005/0204296 discloses a method for sharing a hypermedia document presentation in a browser context between at least two clients. This method includes mechanisms for exchanging continuous interaction events between the clients, coordinating the events and emulating the coordinated interaction events in the replica of the shared presentation. However, this method would not be applicable to a SVG container format with embedded media in non-real time and real time feedback scenarios as well as forward transmission. Additionally, this system does not provide solutions for mapping SVG-side event scripts into feedback requests and the dynamic updating of the SVG content.

### SUMMARY OF THE INVENTION

The present invention provides a system and method for providing feedback formats and transport protocol extensions for SMS, MMS, HTTP and RTSP in order to support remote interactivity dedicated for rich media between a rich media client and a server. The present invention provides a technical solution for forward transmission from a server to a client and feedback from a client to a server in a rich media based SVG presentation. The present invention defines a suitable method for mapping client-side script interaction with SVG into feedback and requests, classifying such feedback mechanisms, and defining new syntax for the added functionality. Based upon the requirements of the application and the UE capability, different transport mechanisms can be used for feedback. These mechanisms may include SMS/MMS (to send text with limited length of text), HTTP, RTSP, RTP control protocol (RTCP) (RTP/AVPF), file delivery over unidirectional transport (FLUTE), and other transport mechanisms. Although MMS is also capable of carrying continuous media (e.g. video, audio) and discrete media (e.g. images), the decision to incorporate such media is application-specific. In addition, the size and temporal characteristics of such media may not be suitable to carry feedback messages via MMS. However, the application may choose to incorporate the media in MMS feedback data. The present invention can also be used in services such as packet-switched streaming service (PSS) and MBMS.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a representation of a method showing the transmission of feedback messages between the server and client in a rich media environment;

FIG. 2 is a representation of a system within which the present invention may be implemented;

FIG. 3 is a perspective view of a mobile telephone that can be used in the implementation of the present invention; and

FIG. 4 is a schematic representation of the telephone circuitry of the mobile telephone of FIG. 3.

### DETAILED DESCRIPTION OF THE PREFERRED EMBODIMENTS

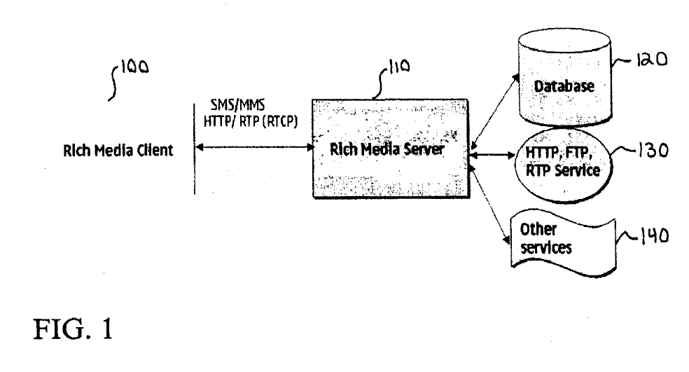

FIG. 1 is a simplified representation of devices that exist or can exist in a rich media sharing environment according the present invention. According to the present invention, a rich media client 100 is in communication with a rich media server. The rich media client and the rich media server can communicate information according to the present invention using systems such as SMS/MMS, HTTP/RTP (RTCP), as well as via other communication methods. The rich media server 110 can obtain rich media content for transmission to the rich media client 100 from devices such as a database 120, a HTTP, FTP and/or RTP service 130, or other services 140.

The present invention provides a system and method for providing feedback formats and transport protocol extensions for SMS, MMS, HTTP and RTSP to support remote interactivity dedicated for rich media between a rich media client and a server. There are several use cases for interactive rich media services. Some examples are as follows.

Dynamic menus. Dynamic menus, also known as dynamic drop-down menus, can be dynamically created on the fly based upon information sent to the client from the server. Such menus may also be created by clicking an item in the menu, which can lead to a request for additional information from the server. A combination of these methods is also possible.

Rich media player with DVD like functionality. The present invention can be used to extend a DVD-like chapter functionality to a rich media player on mobile devices. Similar to a VOB chapter file on a DVD, several media streams (such as video, audio, SVG based subtitles, etc.) can be multiplexed together to form a rich media scene or a scene update. When the user requests a particular chapter as feedback, the corresponding scene or scene update can be streamed to the player.

User voting. Users can send non-real time feedback back to the server, which can later be used for collecting statistics. For example, a user can fill out a survey and send the data to a server to be used later.

Video/song selection services. The present invention can be used to allow the users to select/request a song or movie of their choice at real time from the server and the content update depends on which client sent out the request earlier or based on the priority assigned to each client.

Remote User Interfaces (RUI). The Remote UI is a mechanism that enables user interfaces to be rendered on other devices than those that run the application logic. Manufacturers are currently creating devices that are highly optimized for certain environments. As the devices are intended for a diverse range of purposes, their UI capabilities can vary considerably; the screen size and ratio, color depth, windowing system with various widget sets, input methods, etc. are making the environment highly heterogeneous. At the same time, application developers and UI designers are trying to create user interfaces that are highly optimized for the rendering platform so that the user experience is improved by having the respective application easy to learn and use. When such a remote UI is rendered on another device than the one that is running the application logic, provisions need to be made so that the user can perceive the UI as a local application, making it intuitively usable.

In the above cases, the applications can be either broadcast/multicast-oriented or PtP-oriented. Correspondingly, SMS, MMS, TCP/IP and UDP/IP can be used in both forward and backward transmission. As discussed herein, only the method for providing feedback data is discussed. Techniques and syntax are discussed for extending SMS, MMS, HTTP and RTSP to be capable to provide feedback to server. The capability of each mechanism is then listed and mapped to various use cases.

The application scripts used to process the user events can be saved either in the UE side or the server side. Correspondingly, the user-agent uses a different interaction mode to provide feedback data. The interactions discussed herein are classified into two modes: a locally processed mode and a remotely processed mode. Syntax for the locally processed mode and the remotely processed mode, which is based on XML, are discussed herein and are mapped to the aforementioned transport mechanisms.

SMS, MMS, HTTP and RTSP are four possible methods for transmitting feedback data. However, it should be understood that other transport mechanisms may also be used. In each of these systems, new extensions and syntaxes may be defined based upon various related protocols in order to provide efficient capability for rich media interactions.

Locally and Remotely Processed Events. During the interaction, the application scripts used to process the user interaction can be saved either on the client/UE side or on the server side, with the choice being application-specific. However, based upon the nature of the scheme, a proper transport mechanism may also be chosen for providing feedback data.

Locally processed events are application scripts that are first processed on the client side and, if needed, are transmitted to the server from the UE. For certain applications, scripts may be saved on the UE side. This can greatly reduce the burden of the server and facilitates the local interaction. For example, in the iTV interaction, the manipulation to the user interface can be immediately realized at the UE side, and some form of data can then be sent to the server. In this scenario, the user may choose a channel; the script will process this event and send a PLAY request to the server. This request contains information about the selected channel. Based upon such information, the server may start a new broadcasting or downloading session to transmit the requested media data.

Remotely processed events are application scripts processed directly on the server side. In such a case, the user events are directly sent from the UE to the server without any initial processing. One possible reason of saving the user events in the server side may involve security. The server hides every detail from the end user, so that the client only needs to report information such as which button key has been the clicked by the user, which text has been input by the user, etc.

Generic Feedback payload format. Feedback information dedicated for SVG content can be represented in the form of a text+octet payload. This payload has two parts. The first part contains the EVENT_ID, ELEMENT_ID and the EVENT. The EVENT_ID is a unique identifier which identifies the feedback message from the client. The ELEMENT_ID is the ID of the source element in the SVG DOM that triggers the event. The EVENT is an SVG event or a user defined event. The overall format can be expressed as:
<meta-information>;
EVENT_ID=“ . . . ”;ELEMENT_ID=“ . . . ”;EVENT=“ . . . ”;[OCTET1OCTET2 . . . OCTETN];

The actual feedback data is stored after the first part as a series of octets. This data may contain attributes of the SVG event itself, as referred to at www.w3.org/TR/2004/WD-SVG12-20041027/eventlist.html. For example, the X and Y positions where the button was clicked may be directly transmitted to the server, and the server can process the feedback remotely. Assuming that each of the X and Y values is expressed in binary format with two octets, the totally length of the octet series is 2+2=4 octets. The Y value is stored immediately after the X value.
<meta-information>; EVENT_ID=“ . . . ”;ELEMENT_ID=“my-button1”;EVENT=“click”;[OCTET1OCTET2OCTET3OCTET4];

The above example includes a SVG scene with a set of buttons to select a movie. Upon clicking one of the buttons, the client stores the X and Y positions where the button was clicked. This information is formulated into a remotely processed feedback message to the server. Four octets are used to store this information in this example.

The actual feedback data can also contain the processed information, such as which movie the user selected. In this case, the octets may contain information like “movieSelected=Lord of the Rings”. This would be an example for a locally processed event. Therefore, upon clicking one of the buttons in the scene, a script stores this value in a field called movieSelected. This information is formulated into a locally processed feedback message to the server.

For protocols such as SMS or MMS, the first three items in the payload are specified explicitly in text-based format, and the fourth field is generally regarded as a series of octets. For HTTP POST/PUT, the meta information is stored in the entity-header, while following four text-based fields and the series of octets storing the actual feedback information are stored together and sequentially in the entity-body.

Transport Systems for Feedback. Different transport systems have different capabilities, and their usage depends upon the nature of the rich media application. Many methods, such as MMS, TCP and UDP, can be used to deliver rich media data. Depending upon the demand of the specific application, different methods can be used in both forward transmission and feedback transmission. It should be noted that the method used in feedback channel is not necessarily the same as the method used in forward channel. Therefore, only the method for providing feedback data is discussed herein. Certain extensions are discussed in Table 1 below for commonly used standard protocols, such as SMS, HTTP, MMS and RTSP, to facilitate rich media based feedback.

TABLE 1

| | | | Property | |
|---|---|---|---|---|
| | Forward | Feedback | in Feedback | Extension |
| | Channel | Channel | Scenario | in this scheme |
| SMS | PtP | high | Text-based, | Feedback payload |
| | | delay | limited length | format by SMS |
| | | | (140 octets) | |
| MMS | PtP | high | Text-based (300K | Feedback payload |
| | | delay | octets) | format by MMS |
| HTTP | PtP | low | Suitable for PtP | GET, PUT, POST |
| | | delay | connection, which | |
| | | | need more | |
| | | | guarantee for the | |
| | | | feedback data | |
| RTSP | Broad- | low | Suitable for | PLAY, PUT, |
| | cast | delay | controlling | POST, PSS Base |
| | | | broadcasting | Vocabulary, PSS |
| | | | presentation | Quality of |
| | | | | Experience (QoE), |
| | | | | RTP/AVPF, SDP |

Feedback by SMS and/or MMS. Both SMS and MMS may be to carry text based feedback information, although SMS can carry text with only a limited length of 140 octets. For SMS, given the length limitation of the feedback message, the text-based data needs to be segmented into smaller chunks during transmission. In order to identify the packets, metadata may be used at the head of each packet in the form of: ID of current segment/total number of segments/data format/length of payload/character set.

The third field represents the data format--whether the data is text, binary or unicode. (text-1, binary-2, unicode-3). The fourth field is the length of the payload data, counted in octets. The optional fifth field is the name of the character set when unicode is used. The fifth field exists only when the value of the third field is 3. For example, in 1/3/3/100/ISO-8859-7, the user feedback is divided into three segments. The current SMS message carries the first segment. This segment has a length of 100 octets. Unicode encodes it and the character set is ISO-8859-7. More formally, this metadata can be expressed as:

1*DIGIT “/” 1*DIGIT “/” 1*DIGIT “/” n*DIGIT “/” n*CHAR SP

In this form, 1*DIGIT indicates that there is one digit, “/” is the character “/”, n*DIGIT indicates that there may be one or more digits, n*CHAR indicates that there may be one or more characters, and SP indicates white space. The SMS mode of feedback is ideal for feedback with a high delay, as the latency of SMS is relatively higher than HTTP and RTSP requests.

For MMS, the meta data is of the format: data format/length of payload/character set. In this format, the first field represents the format of the data—whether the data is text, binary or unicode. (text-1, binary-2, unicode-3). The second field is the length of the payload data, counted in octets. The optional third field is the name of the character set, when unicode is used. The third field exists only when the value of the first field is 3. The format is implemented, for example, as 3/100/ISO-8859-7. More formally this metadata can be expressed as:

1*DIGIT “/” n*DIGIT “/” n*CHAR SP

In this example, 1*DIGIT indicates that there is one digit, “/” is the character “/”, n*DIGIT indicates that there may be one or more digits, n*CHAR indicates that there may be one or more characters and SP indicates white space.

Feedback by HTTP. HTTP is an application-layer protocol. HTTP is usually run over a TCP connection, although it is also applicable to other transport protocols such as UDP. HTTP is suitable for interactions based on PtP connections. TCP inherently guarantees the delivery of data packets. However, TCP also introduces additional delay. Therefore, such a system is more suitable for feedback with low delay, such as channel selection or games based on SVG, which need a stronger guarantee for the feedback data. In addition, HTTP is suitable for the progressive-download scenario, in which one or more HTTP GET requests are used to establish the session.

In the following parts, GET, POST and PUT methods are extended to carry the feedback data.

The GET method mechanism retrieves whatever information is identified by the Request-URI. Range and content-range refer to the range of data, with range referring to data from the client to the server (e.g., feedback) and content-range referring to data from the server to the client (e.g., forward transmission). The semantics of the GET method change to a “partial GET” if the request message includes a Range header field. After receiving such kind of request, the server uses a 206 or 416 message, which contains a field referred to as “Content-Range”, to answer the GET request.

In the current HTTP specification, the range and content-range are only specified based on bytes. However, SVG content is not byte-based like audio and video, and HTTP typically treats all data as a simple binary format. Although SVG can potentially be compressed into a binary format for example, binaryXML, all SVG scene and scene update content may not necessarily be compressed into a binary format. Moreover, in the ISO Base Media File Format, the SVG scenes and scene updates are organized and referenced by syncsamples. All syncsamples in SVG are SVG scenes, but all SVG scenes may not necessarily be syncsamples. In order to facilitate uncompressed SVG presentation that is neither byte-based not frame based, the HTTP GET method is extended to be based on milliseconds or syncsamples to increase precision for feedback.

The following shows both syntax and examples for using milliseconds for Range:

SYNTAX:

millisecond-ranges-specifier=milliseconds-unit “=” millisecond-range-set

millisecond-range-set=1#( millisecond-range-spec|suffix-millisecond-range-spec)

millisecond-range-spec=first-millisecond-pos “-” [last-millisecond-pos]

first-millisecond-pos=1*DIGIT

last-millisecond-pos=1*DIGIT

suffix-millisecond-range-spec=“-” suffix-length

suffix-length=1*DIGIT

EXAMPLES of millisecond-ranges-specifier values (assuming an entity-body of length 100000):

The first 5000 milliseconds (millisecond offsets 0-4999, inclusive): milliseconds=0-4999

The second 5000 milliseconds (millisecond offsets 5000-9999, inclusive): milliseconds=5000-9999

The final 5000 milliseconds (millisecond offsets 95000-99999, inclusive): milliseconds=−5000

Or:

milliseconds=95000

The first and last milliseconds only (milliseconds 0 and 99999): milliseconds=0−0,−1

Several legal but not canonical specifications of the second 5000 milliseconds (millisecond offsets 95000-99999, inclusive):

milliseconds=5000-6000,6001 -99999

milliseconds=5000-7000,7001-99999

The following shows both syntax and examples for using syncsamples for Range:

SYNTAX:

syncs ample-ranges-specifier=syncsamples-unit “=” syncsample-range-set

syncsample-range-set=1#(syncsample-range-spec|suffix-syncsample-range-spec)

syncsample-range-spec=first-syncsample-pos “-” [last-syncsample-pos]

first-syncsample-pos=1*DIGIT

last-syncsample-pos=1*DIGIT

suffix-syncsample-range-spec=“-” suffix-length

suffix-length=1*DIGIT

EXAMPLES of syncsample-ranges-specifier values (assuming an entity-body of length 199):

The first 50 syncsamples (syncsample offsets 0-49, inclusive): syncsamples=0-49

The second 50 syncsamples (syncsample offsets 50-99, inclusive): syncsamples=50-99

The final 50 syncsamples (syncsample offsets 150-199, inclusive): syncsamples=−50

Or

syncsamples=150

The first and last syncsamples only (syncsamples 0 and 199): syncsamples=0-0,−1

Several legal but not canonical specifications of the second 50 syncsamples (syncsample offsets 50-199, inclusive):

syncsamples=50-60,61-199

syncsamples=50-70,71-199

The following shows both syntax and examples for using milliseconds for Content-Range:

SYNTAX:

Content-Range = “Content-Range” “:” content-range-spec
content-range-spec = millisecond-content-range-spec
millisecond-content-range-spec = millisecond-unit SP

milsyncsamplenge-resp-spec “/”

( instance-length | “*” )

millisecond-range-resp-spec = (first-millisecond-pos “−”
last-millisecond-pos)

| “*”

instance-length = 1*DIGIT

EXAMPLES of millisecond-content-range-spec values, assuming that the entity contains a total of 20000 milliseconds:
The first 3000 milliseconds:
milliseconds 0-2999/20000
The second 3000 milliseconds:
milliseconds 3000-5999/20000
All except for the first 3000 milliseconds:
milliseconds 3000-20000/20000
The last 3000 milliseconds:
milliseconds 17001-20000/20000

The following shows both syntax and examples for using syncsamples for Content-Range:

SYNTAX:

| Content-Range = “Content-Range” “:” content-range-spec | |
|---|---|
| content-range-spec | = syncsample-content-range-spec |

syncsample-content-range-spec = syncsample-unit SP

syncsample-range-resp-spec “/”
( instance-length | “*” )

syncsample-range-resp-spec = (first-syncsample-pos “−”
last-syncsample-pos)

| “*”

| | |
|---|---|
| instance-length | = 1*DIGIT |

Examples of syncsample-content-range-spec values, assuming that the entity contains a total of 199 syncsamples:
The first 50 bytes:
syncsamples 0-49/199
The second 50 bytes:
syncsamples 50-99/199
All except for the first 50 bytes:
syncsamples 50-199/199
The last 50 bytes:
syncsamples 150-199/199

The POST method is used to request the server to accept the entity enclosed in the request as a new subordinate of the resource identified by the Request-URI in the Request-Line. POST is designed to allow a uniform method to cover the annotation of existing resources; the posting of a message to a bulletin board, newsgroup, mailing list, or similar group of articles; Provide a block of data, such as the result of submitting a form, to a data-handling process; and extend a database through an append operation. The actual function performed by the POST method is determined by the server and is usually dependent on the Request-URI.

The PUT method requests that the enclosed entity be stored under the supplied Request-URI. If the Request-URI refers to an already existing resource, then the enclosed entity should be considered as a modified version of the resource residing on the origin server. If the Request-URI does not point to an existing resource, and that URI is capable of being defined as a new resource by the requesting user agent, then the origin server can create the resource with that URI.

Both POST and PUT requests may transfer an entity if not otherwise restricted by the request method or response status code. An entity includes entity-header fields and an entity-body. Entity-header fields define meta information about the feedback stored in the entity-body or, if no body is present, about the resource identified by the request. The entity-body, if any, sent with an HTTP request or response is in a format and encoding defined by the entity header fields, containing the actual feedback data. The defined SVG feedback data is actually stored and sent in the entity-body. There is no length limitation for the entity-body. It is the responsibility of the lower layer (e.g., the TCP) to handle the segmentation or fragmentation of the large feedback data. An example of the entity-header field and entity-body is as follows.

entity-header = Allow ;

| Content-Encoding;
| Content-Language;
| Content-Length;
| Content-Location;
| Content-MD5;
| Content-Range;
| Content-Type;
| Expires;
| Last-Modified;
| extension-header

extension-header = message-header
entity-body = *OCTET

The fundamental difference between the POST and PUT requests is reflected in the different meaning of the Request-URI. The URI in a POST request identifies the resource that will handle the enclosed entity. That resource might comprise a data-accepting process, a gateway to some other protocol, or a separate entity that accepts annotations. In contrast, the URI in a PUT request identifies the entity enclosed with the request; the user agent knows what URI is intended, and the server must not attempt to apply the request to some other resource. Therefore, according to the demand of the application, the SVG feedback can be sent via PUT or POST, respectively. For example, if the feedback data is a user result for a voting application, the user-agent does not care about where the server will save and process it. In such case, this feedback data will be sent via POST. As another example, if the user-agent tries to upgrade user information in the server, and the script knows where the new data should be stored, a PUT request will be used to transmit the feedback data.

Feedback by RTSP. RTSP is an application-level protocol for control over the delivery of data with real-time properties. This protocol is intended to control multiple data delivery sessions, provide a mechanism for choosing delivery channels such as UDP, multicast UDP and TCP, and provide a method for choosing delivery mechanisms based upon RTP. Therefore, RTSP is suitable to provide feedback with low delay for broadcasting applications.

RTSP is inherently compatible with HTTP. Therefore, in order to provide feedback data, what has been extended on POST/PUT can be applied to RTSP. In addition, the PLAY method is extended to allow the Range to be specified by syncsample. The PLAY method tells the server to start sending data. The PLAY method positions the normal play time to the beginning of the range specified and delivers stream data until the end of the range is reached. The following is one example of such an instruction:

C->S: PLAY rtsp://audio.exarnple.com/audio RTSP/1.0

CSeq: 835

Session: 12345678

Range: npt=10-15

The Range header may also contain a time parameter. This parameter specifies a time in UTC upon which the playback should start. For an on-demand stream, the server replies with the actual range that will be played back. This may differ from the requested range if alignment of the requested range to valid frame boundaries is required for the media source. In order to facilitate the rich media applications, the PLAY command can be extended to allow the Range is specified by syncsample and milliseconds, in a manner similar to the extensions made in HTTP and as discussed previously. The following example plays the whole presentation starting from the 20^{th} syncsample until the end:

C->S: PLAY rtsp://svg.example.com/presentation.svg RTSP/1.0

CSeq: 833

Session: 12345678

Range: syncsample=20

S->C: RTSP/1.0 200 OK

CSeq: 833

Date: 23 Jan. 2005 15:35:06 GMT

Range: syncsample=20

The following example shows a presentation starting from 20^{th} synsample and ending at 40^{th} synsample:

C->S: PLAY rtsp://svg.example.com/presentation.svg RTSP/1.0

CSeq: 834

Session: 12345679

Range: syncsample=20-40

S->C: RTSP/1.0 200 OK

CSeq: 834

Date: 23 Jan. 2005 15:37:06 GMT

Range: syncsample=20-40

For specifying the range in milliseconds, the syntax can be as follows:

C->S: PLAY rtsp://svg.example.com/presentation.svg RTSP/1.0

CSeq: 834

Session: 12345679

Range: millisecond=3000-20000

S->C: RTSP/1.0 200 OK

CSeq: 834

Date: 23 Jan. 2005 15:37:06 GMT

Range: millisecond=3000-20000

The following are a number of alternative embodiments of the present invention. However, it should be understood that a wide variety of other implementations are also possible. In one such implementation, for the generic feedback payload format, the fields in the feedback payload format may be optional or could be ignored depending upon the application and/or the capabilities of the client, server and network conditions. In another implementation, also for the generic feedback payload format, the sequential order and the names of the fields in the feedback payload format may be changed. Additionally, the sequential order and the names of the fields in the feedback format of SMS and MMS may be changed, while still performing the same functions.

For an extension to the POST/PUSH method for feedback by HTTP, the sequential order and the names of the fields in the Range or Content-Range, which are contained in the POST or PUT message, may be changed, while still performing the same functions. Additionally, it should be noted that although the POST and PUT contain data for different purposes, the data contained in the POST request can also be sent by the PUT request or vice-versa.

For feedback by RTSP, the sequential order and the names of the fields in the Range, which are contained in the PLAY message, may be changed, while still performing the same functions. Additionally, the response message from the server to the client does not necessarily have to contain the same range as the range requested by corresponding PLAY request.

Lastly, it should be noted there can also be an option in the syntax where the range contains the total number of samples available. For example, the syntax can indicate “Range: syncsample=20-40/60”, assuming there is a total of 60 samples.

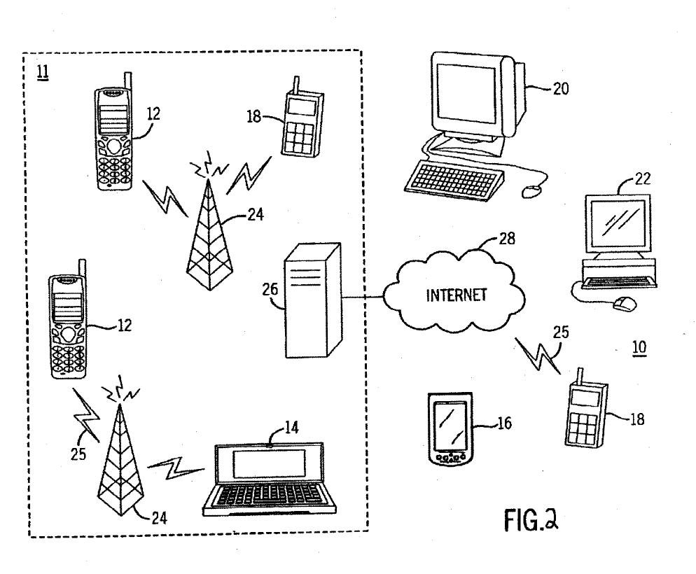

FIG. 2 shows a system 10 in which the present invention can be utilized, comprising multiple communication devices that can communicate through a network. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 2 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, a mobile telephone 12, a combination PDA and mobile telephone 14, a PDA 16, an integrated messaging device (IMD) 18, a desktop computer 20, and a notebook computer 22. The communication devices may be stationary or mobile as when carried by an individual who is moving. The communication devices may also be located in a mode of transportation including, but not limited to, an automobile, a truck, a taxi, a bus, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

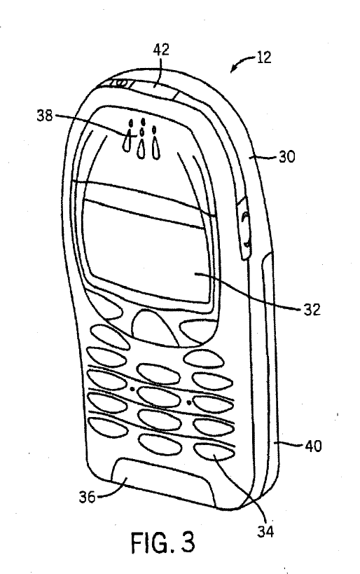

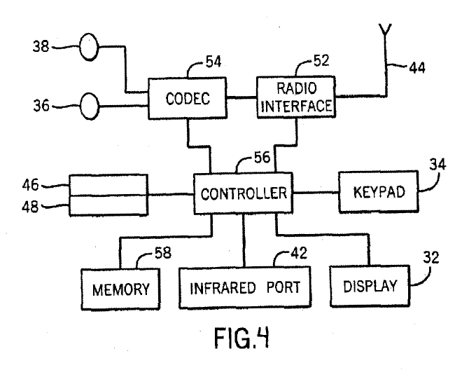

FIGS. 3 and 4 show one representative mobile telephone 12 within which the present invention may be implemented. It should be understood, however, that the present invention is not intended to be limited to one particular type of mobile telephone 12 or other electronic device. The mobile telephone 12 of FIGS. 3 and 4 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

The present invention is described in the general context of method steps, which may be implemented in one embodiment by a program product including computer-executable instructions, such as program code, executed by computers in networked environments.

Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represent examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module” as used herein, and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of providing information concerning rich media content for transmission between a rich media client and a rich media server, comprising:
preparing a text+octect payload of information including:
a first portion having an event, an event identifier, and an element identifier, and
a second portion including data for transmission; and
transmitting the prepared text+octect payload between the rich media client and the rich media server using a predetermined protocol.

2. The method of claim 1, wherein the information comprises feedback information.

3. The method of claim 1, wherein the information comprises forward transmission information.

4. The method of claim 1, wherein the data is stored as a series of octects.

5. The method of claim 1, wherein the data includes attributes of the event.

6. The method of claim 1, wherein the data includes processed information from the rich media client.

7. The method of claim 1, wherein the event comprises an SVG event.

8. The method of claim 1, wherein the event comprises a user-defined event.

9. The method of claim 1, wherein the event identifier is a unique identifier used to identify a feedback message from the rich media client.

10. The method of claim 1, wherein the element identifier is an identifier of a source element that triggers the event.

11. The method of claim 1, wherein the predetermined protocol comprises a multimedia messaging system.

12. The method of claim 1, wherein the predetermined protocol comprises a short messaging system.

13. The method of claim 1, wherein the predetermined protocol comprises hypertext transfer protocol.

14. The method of claim 13, wherein the text+octect payload is carried by an HTTP GET request.

15. The method of claim 14, wherein the text+octect payload includes information to extend the HTTP GET request to be based upon milliseconds.

16. The method of claim 14, wherein the text+octect payload includes information to extend the HTTP GET request to be based upon syncsamples.

17. The method of claim 13, wherein the text+octect payload is carried by an HTTP POST request.

18. The method of claim 13, wherein the text+octect payload is carried by an HTTP PUT request.

19. The method of claim 1, wherein the predetermined protocol comprises real time streaming protocol.

20. The method of claim 1, wherein the text+octect payload is carried by a PLAY request.

21. The method of claim 1, the event in the text+octect payload is processed by the rich media client.

22. The method of claim 1, the event in the text+octect payload is processed by the rich media server.

23. The method of claim 1, wherein the text+octect payload includes a plurality of segments, and wherein each of the plurality of segments includes metadata, the metadata including an indication of the identity of the respective segments, the total number of segments, the format of the data being transmitted, and the length of the text+octect payload.

24. The method of claim 24, wherein the metadata of each of the plurality of segments further includes the name of a character set being used.

25. The method of claim 1, wherein the text+octect payload includes metadata including the format of the data being transmitted, the length of the text+octect payload, and the name of a character set being used.

26. The method of claim 1, wherein the rich media content is selected from the group consisting of SVG content, audio content, video content, images, text and combinations thereof.

27. A computer program product for providing information concerning rich media content for transmission between a rich media client and a rich media server, comprising:
computer code for preparing a text+octect payload of information including:
a first portion having an event, an event identifier, and an element identifier, and
a second portion including data for transmission; and
computer code for transmitting the prepared text+octect payload between the rich media client and the rich media server using a predetermined protocol.

28. The computer program product of claim 27, wherein the predetermined protocol comprises a multimedia messaging system.

29. The computer program product of claim 27, wherein the predetermined protocol comprises a short messaging system.

30. The computer program product of claim 27, wherein the predetermined protocol comprises hypertext transfer protocol.

31. The computer program product of claim 27, wherein the predetermined protocol comprises real time streaming protocol.

32. The computer program product of claim 27, wherein the information comprises feedback information.

33. The computer program product of claim 27, wherein the information comprises forward transmission information.

34. The computer program product of claim 27, wherein the rich media content is selected from the group consisting of SVG content, audio content, video content, images, text and combinations thereof.

35. An electronic device, comprising:
a processor; and
a memory unit operatively connected to the processor and including computer program product for providing information concerning rich media content for transmission between the electronic device and a remote device, comprising:
computer code for preparing a text+octect payload of information including:
a first portion having an event, an event identifier, and an element identifier, and
a second portion including data for transmission; and
computer code for transmitting the prepared text+octect payload between the electronic device and the remote device using a predetermined protocol.

36. The electronic device of claim 35, wherein the predetermined protocol comprises a multimedia messaging system.

37. The electronic device of claim 35, wherein the predetermined protocol comprises a short messaging system.

38. The electronic device of claim 35, wherein the predetermined protocol comprises hypertext transfer protocol.

39. The electronic device of claim 35, wherein the predetermined protocol comprises real time streaming protocol.

40. The electronic device of claim 35, wherein the information comprises feedback information.

41. The electronic device of claim 35, wherein the information comprises forward transmission information.

42. The electronic device of claim 35, wherein the rich media content is selected from the group consisting of SVG content, audio content, video content, images, text and combinations thereof.

43. The electronic device of claim 35, wherein the remote device comprises a rich media server.
